(19) United States
(12) Patent Application Publication
(10) Pub. No.: US 2018/0325641 A1
(43) Pub. Date: Nov. 15, 2018

(54) BODYSUIT FOR ANIMALS

(71) Applicant: Tonua Leigh Williams, Buford, GA (US)

(72) Inventor: Tonua Leigh Williams, Buford, GA (US)

(21) Appl. No.: 16/015,081

(22) Filed: Jun. 21, 2018

Related U.S. Application Data
(63) Continuation of application No. 13/345,072, filed on Jan. 6, 2012, now abandoned.
(60) Provisional application No. 61/431,430, filed on Jan. 10, 2011.

(51) Int. Cl. A61D 9/00; A01K 13/00

(52) U.S. Cl. CPC A61D 9/00; A01K 13/006

(57) ABSTRACT

Devices, methods, and systems for facilitating wound care on an animal are presented. A wound care garment is selectively movable between a closed position and an open position, allowing temporary access to a wound or surgical site and/or exposing the animal's urogenital region without removing the garment. When in the open position, all or most components of the garment may be temporarily stowed away from the wound and away from the urogenital region, thereby keeping the wound and the garment clean, while minimizing the risk of infection.

### CROSS-REFERENCE TO RELATED APPLICATIONS

This application is a continuation of U.S. application Ser. No. 13/345,702, filed Jan. 6, 2012, which claims the benefit of and priority to U.S. Provisional Application No. 61/431,430, filed Jan. 10, 2011, both of which are herein incorporated by reference in their entirety.

### TECHNICAL FIELD

The following disclosure relates generally to garments and methods for covering animals and, in particular, garments and methods for covering wounds and surgery sites on animals during the healing phase.

### BACKGROUND

The Centers for Disease Control and Prevention statistics show that about 4.5 million people suffer dog bites in the United States annually. Almost one in five of them—about 885,000—require medical attention for dog bite injuries. Not all of these are the classic pit bull attacks that make the evening news. To the contrary, most result from an owner being bitten by their own animal while that animal is in pain. Any animal that is in pain may be prone to bite.

American Veterinary Medical Association statistics show that the most common cause of injury in veterinary hospitals is animal bites. The AVMA reported that, in 2008, an insurance company that insures approximately 22,000 animal hospitals in the United States reported claims totaling approximately $8.3 million due to dog bites. Dog bites account for 90% of the injuries that occur in veterinary hospitals. AVMA statistics show that 48% of these bites are to an animal health technician, 24% to veterinary assistants, 9% to veterinarians, 6% to veterinary receptionists, 4% to kennel help, and 9% to others. Eighty-one percent of the bites occur while care is being provided to an animal. Moreover, 67% of the bite wounds occur while a caregiver is providing care to a painful wound on the animal.

About two thirds of veterinary hospitals reported to the AVMA that veterinary workplace safety needs improvement. At the same time, hospitals in the same poll stated that only 47% of aggressive or feared dogs were muzzled, and only 12 to 14% of animals not showing any warning sign were muzzled. Why muzzle use is reportedly low can be attributed to two primary reasons: lack of adequate training and the lack of availability of a muzzle.

Bites from animals in pain do not occur only to persons working in veterinary care centers, however. Upon discharge from a veterinary hospital, pet owners frequently must provide home care for one or more weeks. Owners at home are confounded with the same issues and suffer from similar injuries, statistically, as described in veterinary settings.

In addition to the risk of bites, owners must grapple with the animal's attempts to remove its sutures or lick the wound area by licking, biting, or scratching. To discourage this behavior, the most common apparatus given to owners is a cone-shaped collar sometimes called an Elizabethan collar. This collar is made of plastic or another hard material, worn around the animal's head. While the collar is generally effective in preventing the animal from reaching its wounds with its mouth, the cone nonetheless interferes with the ability of the animal to eat, sleep, and move about. The collar also requires the caregiver to work near or around the animal's head—the area responsible for all bites. The collar also does not prevent the animal from using its feet or paws to scratch or pull at the wounds.

Thus, there is a need in the art for an apparatus that protects animal wounds and surgical sites, limits the animal's access to the wound site, and lowers the risk of bites from animals during recovery.

### SUMMARY

Presented herein are unique solutions to the problems encountered in post-operative and general wound care for animals.

In one embodiment, a garment for an animal comprises a torso portion and a rear portion. The torso portion defines a neck opening and two front leg openings. The torso portion extends rearwardly along the back region of an animal from the neck opening to a tail region. The rear portion defines a tail opening. The rear portion extends rearwardly from the tail region to about the belly region of the animal. The rear portion is selectively movable from a closed position to an open position. The rear portion comprises a central panel and a pair of straps. The central panel is sized and shaped to substantially cover the urogenital region of the animal. The pair of straps is sized and shaped to extend from the belly region to about the back region of the animal, where the straps are releasably fastened.

In another embodiment, a garment for selectively covering the urogenital region of an animal comprises a central panel and a pair of straps. The urogenital region extends from about the tail region downward to about the belly region. The central panel defines a tail opening and is sized and shaped to substantially cover the urogenital region. The central panel is selectively movable from a closed position to an open position. The pair of straps extend from the central panel and are sized in length to extend from the belly region to about the back region of the animal, where the straps are releasably fastened.

Other apparatuses, methods, systems, features, and advantages of the disclosed embodiments will be apparent to one of ordinary skill in the art upon examination of the following figures and detailed description, or may be learned by practicing. All such additional apparatuses, methods, systems, features, and advantages are intended to be included within this description and to be included within the scope of the accompanying claims. The descriptions herein are not restrictive, but instead are exemplary and explanatory only.

### BRIEF DESCRIPTION OF THE DRAWING

FIG. 1 is a perspective view of a garment partially covering an animal, according to particular embodiments.

FIG. 2 is a perspective view of a garment partially covering an animal, according to particular embodiments.

FIG. 3 is a perspective view of a garment releasably fastened about an animal, according to particular embodiments.

FIG. 4 is a perspective view of a garment in a closed position, releasably fastened about an animal, according to particular embodiments.

FIG. 5 is a perspective view of the top side of a garment, according to particular embodiments.

FIG. 6 is a perspective view of the bottom side of a garment, according to particular embodiments.

FIG. 7 is a perspective view of a garment in a partially open position, according to particular embodiments.

FIG. 8 is a perspective view of a garment in a partially open position, according to particular embodiments.

FIG. 9 is a perspective view of a garment in an open position, exposing the hindquarters of an animal, according to particular embodiments.

FIG. 10 is a perspective view of the top side of a garment, with a removable cover, according to particular embodiments.

FIG. 11 is a perspective view of the top side of a garment, with a removable cover and a length of fabric suitable for use as a muzzle, according to particular embodiments.

FIG. 12 is a perspective view of an animal having a back region, a tail region, a urogenital region, and a belly region.

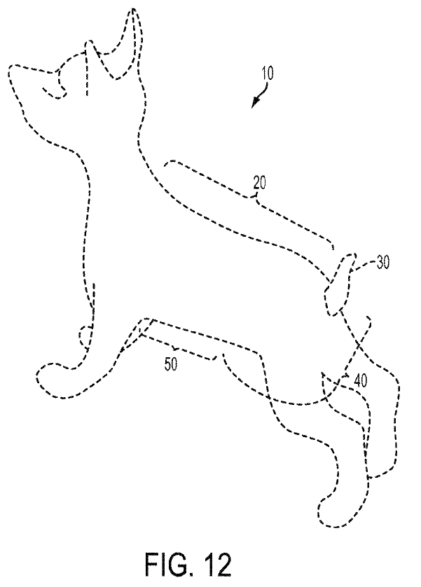

### DETAILED DESCRIPTION

The present systems and apparatuses and methods are understood more readily by reference to the following detailed description, examples, drawing, and claims, and their previous and following descriptions. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching in its best, currently known embodiment. To this end, those skilled in the relevant art will recognize and appreciate that many changes can be made to the various aspects described herein, while still obtaining the beneficial results of the technology disclosed. It will also be apparent that some of the desired benefits can be obtained by selecting some of the features while not utilizing others. Accordingly, those with ordinary skill in the art will recognize that many modifications and adaptations are possible, and may even be desirable in certain circumstances, and are a part of the invention described. Thus, the following description is provided as illustrative of the principles of the invention and not in limitation thereof.

As used throughout, the singular forms “a,” “an” and “the” include plural referents unless the context clearly dictates otherwise. Thus, for example, reference to “a” component can include two or more such components unless the context indicates otherwise. Also, the words “proximal” and “distal” are used to describe items or portions of items that are situated closer to and away from, respectively, a user or operator. Thus, for example, the tip or free end of a device may be referred to as the distal end, whereas the generally opposing end or handle may be referred to as the proximal end.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

### Garment

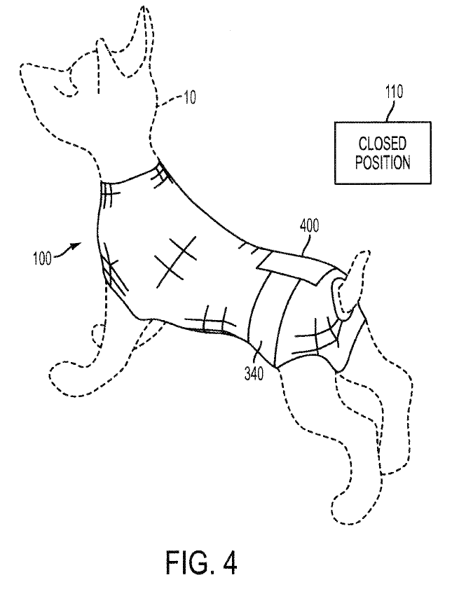

In one embodiment, a garment to be worn by an animal covers at least part of the torso and the hindquarters and includes a selectively releasable fastener. FIG. 4 illustrates an exemplary garment in its donned or closed position 110 on an animal 10. Such a garment may be used to protect a wound or surgical site anywhere on the body, or to otherwise clothe an animal for any purpose. In various embodiments, the garment may be produced in various sizes and shapes, in order to fit any of a variety of animals, including but not limited to companion pets such as dogs and cats, horses and other livestock, zoo animals, and wild animals.

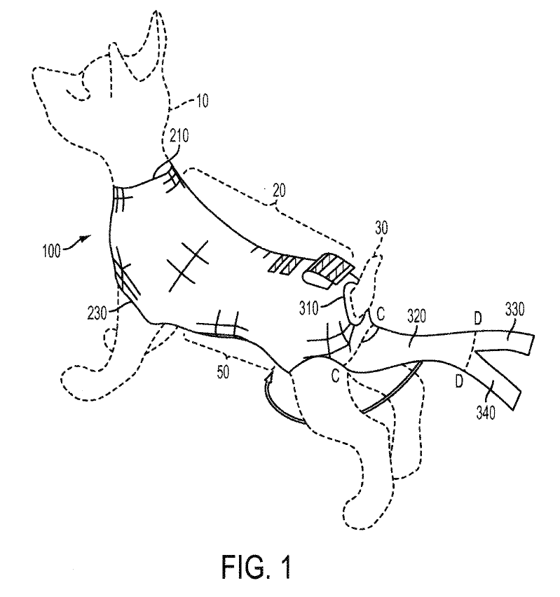

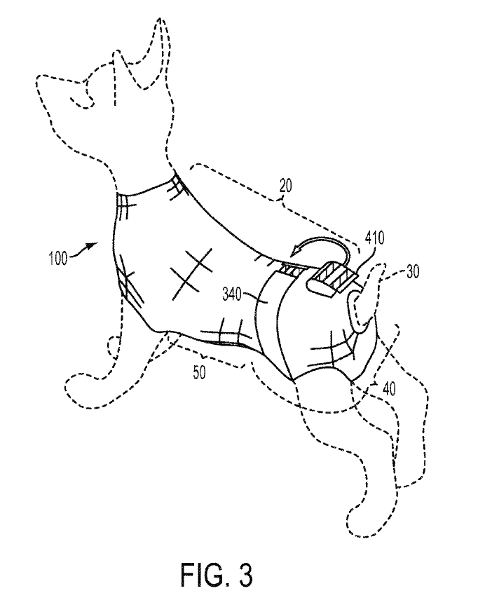

For illustrative purposes, the animal 10 shown in FIG. 1 is a dog. As shown, the animal 10 has a back region 20, a tail region 30, and a belly region 50. The back region 20 may extend from near the neck or withers to near the root of the tail. The tail region 30 includes the tail. The belly region 50 includes the underside of the abdomen. Also, as illustrated in FIG. 3, the urogenital region 40 is located generally between the tail region 30 and the belly region 50. The urogenital region 40 refers to the external region of the body near where the organs of reproduction and waste excretion are located.

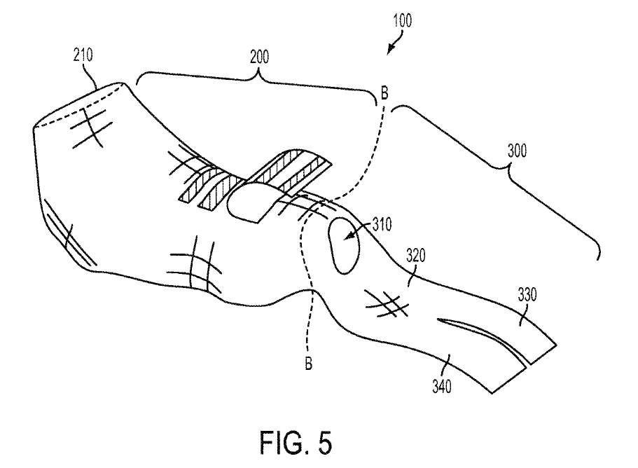

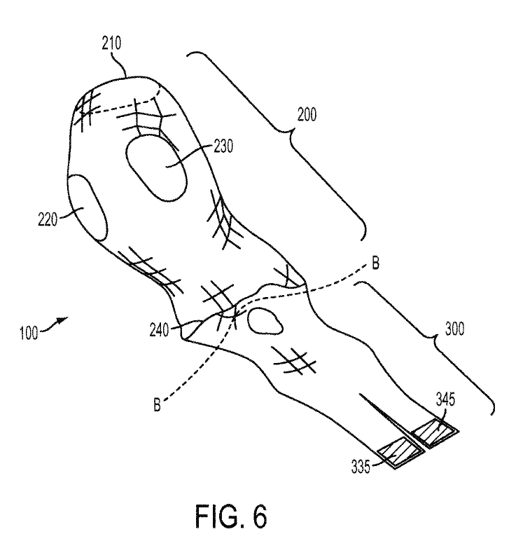

FIG. 1 illustrates a garment 100 in the process of being placed on an animal 10, in one embodiment. FIG. 5 illustrates a garment 100, by itself, in approximately the same orientation as the one illustrated in FIG. 1, but without showing the animal. As shown in FIG. 5, the garment 100 in one embodiment includes a torso portion 200 and a rear portion 300. The torso portion 200 includes a neck opening 210. The rear portion 300 includes a tail opening 310, a central panel 320, and a first strap 330 and a second strap 340. FIG. 6 is a bottom view of the garment 100. As shown, the torso portion 200 includes a neck opening 210 and two front leg openings 220, 230.

Along the top or back side of the garment 100, as shown in FIG. 5, the torso portion 200 ends and the rear portion 300 begins, in various embodiments, along or near line B-B. Line B-B is an approximate border region between the torso portion 200 and the rear portion 300 and is provided as a point of reference only.

FIG. 6 is a perspective illustration of the garment 100 from below. Along the bottom or belly side of the garment 100, as shown, the torso portion 200 in various embodiments extends from the neck opening 210 to a belly opening 240.

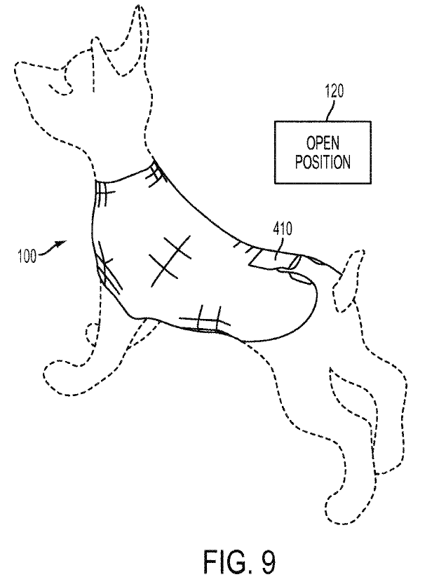

As illustrated in FIG. 1, the rear portion 300 of the garment, in one embodiment, includes a central panel 320 and a pair of straps 330, 340. The rear portion 300 may be sized and shaped to extend from the tail region 30, down and around the urogenital region 40 (shown in FIG. 3), and between the hind legs to the belly region 50 of the animal 10. The rear portion 300 in various embodiments is selectively movable from an open position 120 (illustrated in FIG. 9) to a closed position 110 (FIG. 4).

The rear portion 300 includes a tail opening 310 for receiving the animal's tail therethrough. In one embodiment, the tail opening 310 is sized and shaped to receive the tail without exposing the anus of the animal.

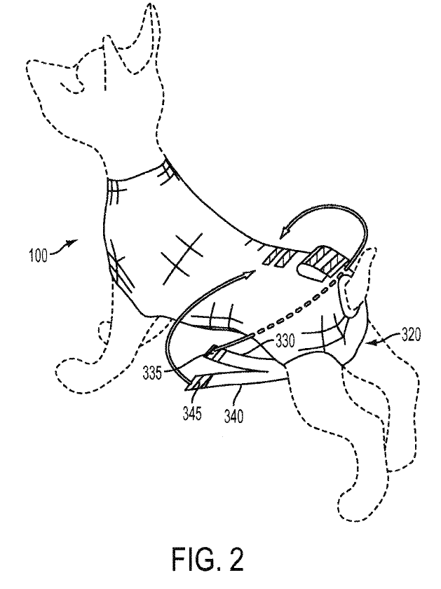

As illustrated in FIG. 2, the rear portion 300 includes a central panel 320 which, in some embodiments, may be sized and shaped to substantially cover the urogenital region 40 of the animal. The central panel 320, as shown in FIG. 1, in one embodiment, may extend from a region along or near line C-C to along or near line D-D where the two straps 330, 340 begin. These lines C-C and D-D are approximate border regions and are provided only as a guide. In one embodiment, the central panel 320 may be generally rectangular in shape, having a width sufficient to substantially cover the urogenital region 40.

Extending from the central panel 320 is a pair of straps 330, 340. As shown in FIG. 2, the first strap 330 may include a distal end region 335, and the second strap 340 may include a distal end region 345. The straps 330, 340 may be sized and shaped to extend from the belly region 50, up and around the sides of the body, and onto the back region of the animal, as illustrated in FIG. 3. The straps 330, 340 in one embodiment may be releasably fastened on or near the back region of the animal. For example, the straps 330, 340 may be hand-tied together. FIG. 4 illustrates a garment in a closed position 110, in one embodiment, characterized by the straps 330, 340 being releasably fastened and by the garment substantially covering the urogenital region of the animal.

### Keeper

As illustrated in FIG. 3 and FIG. 4, the garment may optionally include a keeper 400 for retaining at least a portion of the straps 330, 340 on or near the back region of the animal. A keeper as used herein includes any device that holds or keeps something in a desired position. The keeper 400, in one embodiment, may cooperate with and releasably hold the distal end regions 335, 345 of the straps. For example, the keeper 400 and end regions 335, 345 may include the cooperative panels of a hook-and-loop fastener system known as Velcro®. The keeper 400 may be positioned anywhere that effectively retains at least a portion of the straps 330, 340 to help keep the garment on the animal, in its closed position 110.

In a preferred embodiment, the keeper 400 may be located on the back region of the animal near and above the root of the tail because most animals have great difficulty reaching this area with the mouth or paws.

In one embodiment, in order to further limit access by the animal, the keeper 400 may include a cover 410 such as a flap, as shown in FIG. 3 and FIG. 4. Even if the animal could reach the area where the straps 330, 340 are releasably fastened or held by a keeper 400, the cover 410 provides additional protection against removal of the garment by the animal.

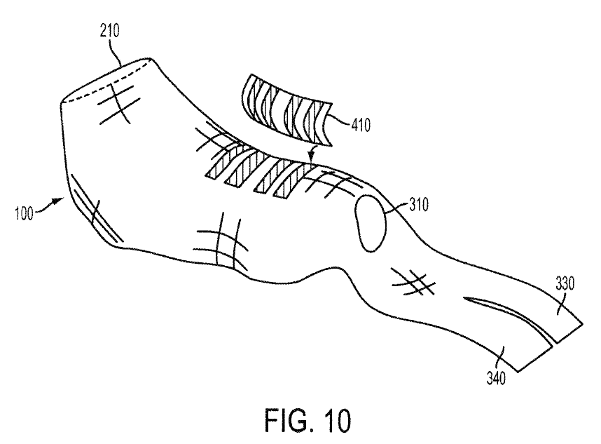

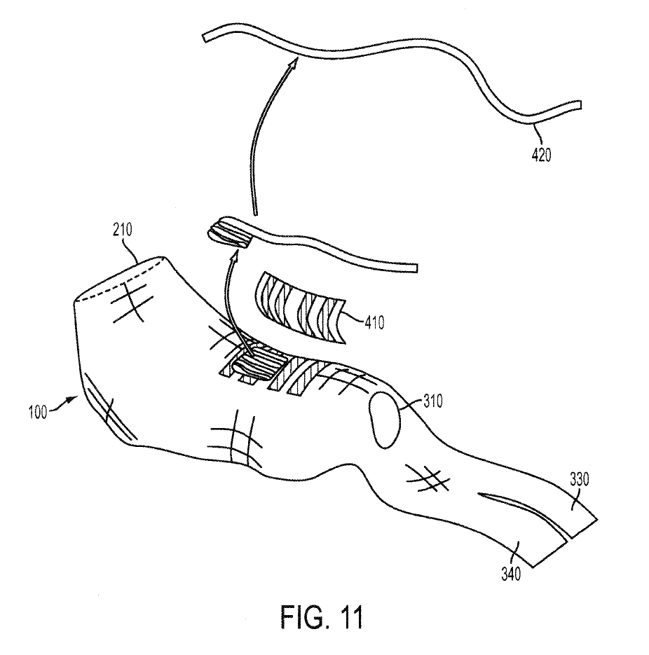

The cover 410 may or may not be attached to the garment. In one embodiment, the cover 410 may be fully removable, as illustrated in FIG. 10. Optionally, the keeper 400 and cover 410 may be sized and shaped to temporarily store any of a variety of items, such as one or more lengths of fabric suitable for use as a leash or muzzle 420, as illustrated in FIG. 11. In use, a caregiver or veterinary worker might use the muzzle 420 to temporarily muzzle an animal when removing or opening the garment; for example, to check the condition of a wound or surgical site.

### Material

The garment in its closed position 110, as illustrated in FIG. 4, may be secured around the animal, as described, by using the straps 330, 340 and the keeper 400. In one aspect, the straps 330, 340 may be used to create a relatively tight fit of the garment around the animal. The garment in various embodiments is made of an elastic material. The garment's elasticity facilitates easy positioning and removal of the garment, while also allowing the animal substantial freedom of movement without pulling the garment out of place or moving the garment across a wound site. In this aspect, an elastic garment reduces fabric movement near the wound site, thereby reducing irritation and the risk of infection. In another aspect, using an elastic fabric for the garment helps keep surgical dressings secure—including sutures, bandages, and the like—without the use of tape or other securing means, such as gauze wrapping.

The garment material in various embodiments may be a tightly-woven or tightly-knit, multi-way stretch fabric. In one embodiment, the garment may be made of fabric that is approximately ninety-two percent cotton and eight percent spandex (also known as Lycra®). Such a 92/8 fabric combination provides consistent flexibility and support in multiple directions. Other fabric combinations are suitable for use as long as they provide adequate stretch and elasticity.

The garment 100 in various embodiments may be made in any of a variety of shapes and sizes in order to fit any particular animal. As illustrated in FIG. 1, for example, the garment 100 may be sized and shaped to fit on a typical dog of a certain general size. In one embodiment, a garment may be custom-tailored to fit a specific dog. In other embodiments, the garment may be offered in a variety of intermediate sizes (e.g., small, medium, large) and shapes (e.g., tall, short, long; light, heavy). In this aspect, using an elastic fabric helps that garment fit acceptably well on animals in a particular size range. In one embodiment, referring to FIG. 1, the garment size may be selected based on the animal's body weight, the length of the back region 20 (from the withers to the root of the tail), and/or the circumference of the trunk, just behind the front legs. In one embodiment, the length of the back region 20 may be used as a guide for both the torso portion 200 and the rear portion 300 of the garment (FIG. 5). In this particular embodiment, the length of the torso portion 200 may be approximately equal to the length of the back region 20, and the length of the central panel 320 (FIG. 1) of the rear portion 300 may be also approximately equal to the length of the back region 20.

In another aspect, the garment in various embodiments provides a gentle compression of the body which helps facilitate the healing process. Compression by the garment may also help to calm an animal that is in pain or distress.

In various embodiments, the fabric of the garment around the front leg openings 220, 230 (FIG. 6) and/or the tail opening 310 may be unfinished; in other words, not stitched or hemmed. Not hemming the openings helps the garment slip over the front legs and/or tail of the animal more easily and effectively. Other devices such as bodysuits and wraps, in contrast, may include tightly fitted openings. Such devices with tight-fitting openings are often difficult to place, adjust, and remove, thereby increasing animal discomfort and the risk of bites. The garment described herein is tailored with unfinished openings so that putting the garment on requires comparatively little effort and manipulation of the animal, especially because the animal is typically in pain and/or recovering from surgery or an injury.

In one embodiment, the edge of the garment fabric around the front leg openings 220, 230 and the tail opening 310 is unfinished and pinked in order to minimize fraying. A pair of pinking shears (or a pinking blade) makes a saw-toothed or zigzag edge instead of a straight edge. Although it does not completely prevent fraying, a pinked edge limits the length of the frayed thread and thereby minimizes the potential damage to the surrounding garment. In practice, a veterinarian or other use may cut one or more openings in the fabric (using pinking shears or a pinking blade, for example) and thereby add a durable and customized opening precisely where it is needed on a particular animal.

One or more openings may be placed in the elastic fabric, in various embodiments, without significantly compromising the overall support provided by the garment. For example, one or more holes may be cut in the fabric to accommodate post-surgical drains, to make an access panel at a particular location, or to provide an additional anchor point for a bandage (as described below).

In addition, the garment resists tearing, thereby increasing durability. It washes and dries quickly and easily, maintains its shape and fit and defies shrinking.

### Open Position

The rear portion 300 of the garment in various embodiments is selectively movable from a closed position 110 (illustrated in FIG. 4) to an open position 120, as illustrated in FIG. 9. Opening the rear portion of the garment allows the animal to urinate or defecate without soiling the garment. Opening the rear portion of the garment also allows a caregiver to access a healing wound or surgical site.

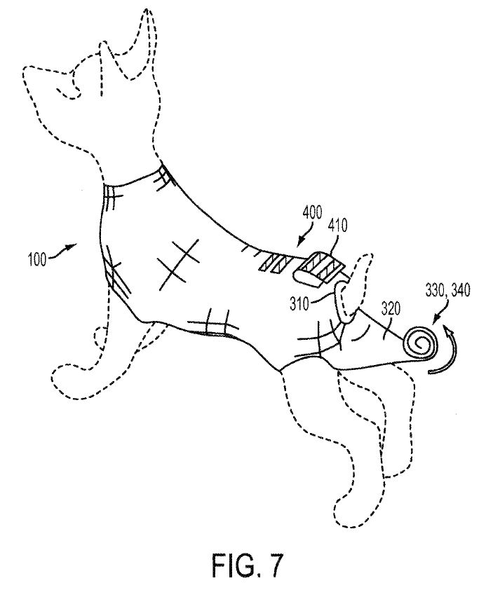

Opening of the rear portion 300 of the garment described herein is substantially easier than opening other devices such as bodysuits and wraps that include fitted leg holes for the hind legs. An animal in pain—especially one recovering from surgery in or around the hindquarters (such as spaying or neutering)—is unlikely to feel comfortable, remain still, or remain calm during removal of a device that requires the hind legs to be maneuvered through fitted leg holes. Forcing the hind legs through fitted hind leg holes increases the risk of biting by an animal in pain or discomfort. In contrast, the garment described herein is easy to open. As illustrated, beginning with FIG. 7, the rear portion of the garment may be opened, in various embodiments, by simply releasing the straps 330, 340, rolling or otherwise gathering together the straps 330, 340, and raising the rear portion including the central panel 320 upward to expose the urogenital region of the animal.

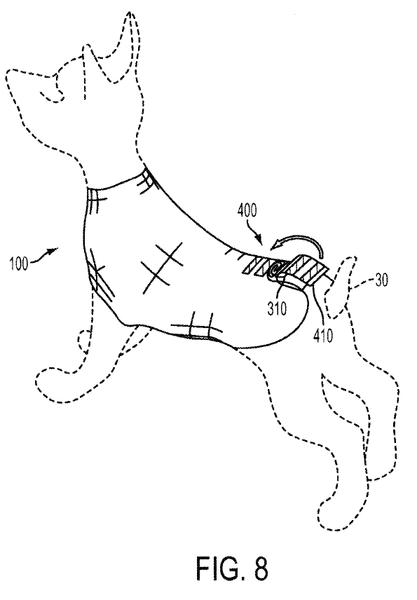

Next, as illustrated in FIG. 7 and FIG. 8, the tail opening 310 (defined by the rear portion 300) may be raised over the tail 30, so that the anus in particular is exposed. In various embodiments, the rear portion of the garment may be pulled forward toward the neck region of the animal, away from the hindquarters. On the belly side, the belly opening 240 may be pulled forward, especially for male animals, to further expose the hindquarters. In embodiments where the garment is made of an elastic material, the stretch of the fabric may allow all or most components of the rear portion to remain forward and away from the hindquarters. In other embodiments, the straps 330, 340 may be pulled forward and tucked into the neck opening 210 or a collar. Also, in other embodiments, releasable fasteners may be provided on or near the back region to secure the straps 330, 340 and other components while the rear portion is in its open position.

In an embodiment that includes a keeper 400 and a cover 410, as illustrated in FIG. 8, the cover 410 may be pulled through the tail opening 310. Next, all or most components of the rear portion may be placed on the keeper and secured by the cover 410, as illustrated in FIG. 9. As shown, the rear portion in its open position exposes most or all the urogenital region of the animal.

Several advantages are provided by stowing all or most components of the rear portion (the straps 330, 340 and central panel 320 and tail opening 310) on the back region of the animal. For example, as opposed to the belly region, the back region offers a preferred place for stowing because the garment is up and away from the urogenital region and also away from the ground. Storage on the back keeps the garment clean, frees the hindquarters, and minimizes the risk of infection to belly wounds and surgical sites.

Some other devices such as bodysuits and wraps include no place for stowing pieces while the animal is urinating or defecating, or during inspection or treatment of a wound or surgical site. Other devices suggest or require tucking rearmost portions or pieces into a bodysuit or wrap, underneath the hindquarters—precisely beneath where the urogenital organs are located. Storing pieces of a device below the urogenital region exposes those pieces to urine and feces. Tucking pieces into the interior side of a device potentially soils the inside surface, next to the animal's body, where the wound or surgical site is located. Once soiled, such devices are no longer fit for use as a protective covering because they would increase the risk of infection. In contrast, the garment described herein keeps all or most of the components of the rear portion 300 on or near the back region of the animal, above the urogenital region and away from urine and feces, and on the exterior surface of the garment, away from the wound or surgical site.

### Uses

As described in several embodiments, the garment may be used to cover a wound or surgical site. In this aspect, the garment represents an alternative to the plastic cone-shaped collar.

The garment as described also provides gentle compression, which helps to calm an animal that is in pain or any kind of distress; for example, during thunderstorms, kennel boarding, or when traveling by air, boat, or motor vehicle.

The garment also provides general coverage of the body, thereby allowing skin irritations or infections to heal while also inhibiting scratching and licking. The garment may also be helpful in containing shedding hair.

Because the garment covers the urogenital region, the garment may also be used together with absorbent pads for animals that are in estrus or incontinent.

Placing the garment described herein on an animal may begin with the step of placing the animal's head through the neck opening 210 and the front legs through the leg openings 220, 230. As illustrated in FIG. 1, the garment 100 may then be pulled rearward along the trunk of the animal, covering at least part of the back region 20 and the belly region 50. The task of placing the garment 100 on the animal, in some cases, may be accomplished while the animal is sedated or otherwise at least partly immobilized.

For embodiments of the garment 100 that include a keeper 400, at least part of the rear portion 300 of the garment may be stored on or in the keeper 400. To put the rear portion 300 in its closed position, the rear portion 300 may be removed from its storage location and unfurled, as illustrated in FIG. 1. The tail 30 may be placed through the tail opening 310.

Next, the central panel 320 and straps 330, 340 may be pulled downward, between the hind legs, and toward the belly region 50 of the animal, as illustrated in FIG. 2. Then, the straps 330, 340 may be pulled upward, around the trunk of the animal, to the back region 20 where the straps 330, 340 may be releasably fastened, as illustrated in FIG. 3. As described the releasable fastening of the straps 330, 340 may be accomplished by cooperating hook-and-loop fastener panels (as shown), mating snaps, hooks and eyes, buttons and holes, bandage clips, zippers, releasable adhesive, tape, or any other suitable fastener. In certain circumstances, the straps 330, 340 may be hand-tied to one another. FIG. 4 illustrates an exemplary garment 100 in closed position 110 on an animal 10.

Opening the garment, in various embodiments, may be begin with the step of releasing the straps 330, 340, rolling or otherwise gathering together the straps 330, 340, and raising the rear portion including the central panel 320 upward, and then forward, in order to expose the urogenital region of the animal, as illustrated in FIG. 7. Next, as illustrated in FIG. 8, the tail opening 310 may be raised over the tail 30, so that the anus in particular is exposed. In various embodiments, the rear portion of the garment may be pulled forward toward the neck region of the animal, away from the hindquarters. On the belly side, the belly opening 240 may be pulled forward, especially for male animals, to further expose the hindquarters.

The straps 330, 340 may be pulled forward toward the head of the animal. In one embodiment, when the straps are pulled forward, along the back region of the animal, most or all of the rear portion 300 of the garment will remain in place, leaving the urogenital region substantially uncovered. In one embodiment, the straps 330, 340 may be tucked into the neck opening 210 or collar. In other embodiments, releasable fasteners may be provided on or near the back region to secure the straps 330, 340 and other components while the rear portion is in its open position. In an embodiment that includes a keeper 400 and a cover 410, as illustrated in FIG. 8, the cover 410 may be pulled through the tail opening 310. Next, all or most components of the rear portion may be placed on the keeper and secured by the cover 410, as illustrated in FIG. 9.

As shown in FIG. 9, the rear portion in its open position exposes most or all the urogenital region of the animal—without removing the front or torso portion 200 of the garment. Allowing the garment to remain on the head and front legs of the animal reduces the effort and struggle required to temporarily open the garment (to inspect a wound or allow the animal to urinate or defecate) and, accordingly, reduces the potential pain or discomfort to the animal, which, in turn, reduces the bite risk to the caregiver.

As described generally above, using an elastic fabric for the garment provides gentle compression, helps keep surgical dressings securely in place, and allows the animal to move freely without irritating the wound. The garment, in various embodiments, may be used to create a customized support garment having one or more openings selectively located by the user. For example, in order to accommodate a post-surgical drain, a veterinarian may cut a hole in the fabric at a location that is best suited to support the drain. A user, for example, may make a custom-located window or access panel in the fabric in order to gain quick access to a particular location inside the garment, without removing the garment. The elastic fabric lets users create any kind of opening, in a desired location, for any particular need.

In another example, a user may cut the fabric in one or more desired locations in order to make additional anchor points for a bandage such as a gauze wrap. When bandaging a front leg, for example, one or more turns of the wrap may travel upward along the garment (either outside or inside), pass through one or more custom-located openings in the fabric, and then return to the leg. Thus, the fabric openings help to stabilize the bandage and keep it from slipping down. The openings may be elongated in shape, like button holes, for example, and may be oriented in any desired direction to support the bandage. Of course, such a bandage or wrap may also pass through the neck opening 210 (FIG. 1) and/or front leg openings 220, 230 (FIG. 6), either alone or together with one or more custom-located openings in the fabric. In this aspect, an opening in the garment may be used as an additional anchor point for a bandage or dressing.

### Conclusion

Although the garment described herein protects and secures wounds located anywhere under the fabric, it is particularly useful for post-operative care in animals that have been spayed or neutered. The rear portion of the garment will cover any wound or surgical site, which may include sutures, particularly in the urogenital region or lower abdomen. Both spaying and neutering involve an incision on the belly region of the animal; usually with post-surgical sutures. After spaying or neutering, the entire urogenital region including the anus, genitals and lower abdomen, should be protected from the animal's licking of the wound or pulling at sutures for several days to at least a week after the surgery.

Although Velcro® is described as the manner of releasable attachment for one or more elements herein, other types of releasable fasteners may be used, alone or in combination with Velcro®, including but not limited to hand-tying, mating snaps, hooks and eyes, buttons and holes, bandage clips, zippers, releasable adhesive, and tape. However, Velcro® has been found to be particularly useful for the components described herein because it is easy to use and readily attachable to the fabric of the garment.

Although the systems, methods, and products are discussed in the context of a post-surgical wound care garment for animals, the technology disclosed herein is also useful and applicable in other contexts. Moreover, although several embodiments have been described herein, those of ordinary skill in art, with the benefit of the teachings of this disclosure, will understand and comprehend many other embodiments and modifications for this technology. The invention therefore is not limited to the specific embodiments disclosed or discussed herein, and that may other embodiments and modifications are intended to be included within the scope of the appended claims. Moreover, although specific terms are occasionally used herein, as well as in the claims or concepts that follow, such terms are used in a generic and descriptive sense only, and should not be construed as limiting the described invention or the claims that follow.

What is claimed is:

1. A garment for an animal, comprising:
a torso portion defining a neck opening and two front leg openings, wherein said torso portion is sized and shaped to extend rearwardly along the back region of an animal from said neck opening to a tail region; and,
rear portion defining a tail opening, wherein said rear portion comprises:
(a) a central panel extending rearwardly from said torso portion to about a belly region of said animal, wherein said central panel is sized and shaped in a single piece to cover substantially all of a urogenital region of said animal when said rear portion is in a closed position; and,
(b) a pair of straps extending upwardly from said central panel to about said back region of said animal where said pair of straps are releasably fastened when said rear portion is in said closed position, wherein: the rear portion is selectively moveable from an open position to said closed position; when the rear portion is in the closed position the anus of the animal is covered; and when the rear portion is in the open position, the animal can urinate or defecate without soiling the garment.

2. The garment of claim 1, wherein said pair of straps are releasably fastened adjacent said back region of said animal by fastener elements selected from the group consisting of cooperating hook-and-loop fastener panels, mating snaps, hooks and eyes, buttons and holes, bandage clips, zippers, releasable adhesive, and tape.

3. The garment of claim 1, further comprising:
a keeper positioned adjacent said back region of said animal, said keeper comprising one or more selectively releasable fasteners configured to cooperate with and retain said pair of straps.

4. The garment of claim 3, wherein said keeper further comprises a cover sized and shaped to protect said pair of straps from inadvertent release, wherein said keeper and said cover cooperate to form a pocket for storing an article.

5. The garment of claim 1, wherein said garment is made of elastic fabric.

6. The garment of claim 1, wherein said garment is made of elastic fabric comprising about ninety-two percent cotton and about eight percent spandex.

7. The garment of claim 1, wherein said garment is made of elastic fabric and wherein one or more of said two front leg openings and said tail opening comprises a pinked edge.

8. The garment of claim 1, wherein said open position is characterized by said pair of straps being released from adjacent said back region, and said rear portion being raised, such that said urogenital region is substantially uncovered.

9. The garment of claim 8, wherein said garment is made of elastic fabric sufficiently fitted to said animal such that at least a majority of said rear portion remains substantially away from said urogenital region without a fastener.

10. The garment of claim 1, wherein said torso portion extends along the back of said animal for a first distance as measured from the withers to the root of the tail of said animal, and wherein said central panel is sized in length to substantially equal said first distance.

11. A garment for selectively covering the urogenital region of an animal, said urogenital region extending from about the tail region downward to about the belly region of said animal, said garment comprising:
a central panel, wherein said central panel defines a tail opening adjacent said tail region and wherein said central panel is sized and shaped in a single piece to cover substantially all of said urogenital region, and wherein the tail opening is sized and shaped to receive the tail without exposing the anus of said animal; and
a pair of straps extending from said central panel and sized in length to extend from said belly region to about the back region of said animal, where said pair of straps are releasably fastened when said central panel is in said closed position,
wherein:
the central panel is selectively moveable from an open position to a closed position;
when the central panel is in the closed position the anus of the animal is covered; and
when the central panel is in the open position, the animal can urinate or defecate without soiling the garment.

12. The garment of claim 11, further comprising:
a keeper positioned adjacent said back region of said animal, said keeper comprising one or more selectively releasable fasteners configured to cooperate with and retain said pair of straps.

13. The garment of claim 12, wherein said keeper further comprises a cover sized and shaped to protect said pair of straps from inadvertent release, wherein said keeper and said cover cooperate to form a pocket for storing an article.

14. The garment of claim 11, wherein said garment is made of elastic fabric.

15. The garment of claim 11, wherein said garment is made of elastic fabric comprising about ninety-two percent cotton and about eight percent spandex.

16. The garment of claim 11, wherein said open position is characterized by said pair of straps being released from adjacent said back region, and said central panel being raised, such that said urogenital region is substantially uncovered.

17. The garment of claim 14, wherein said elastic fabric of said torso portion, said neck opening, and said two front leg openings cooperate, after insertion of said animal's head through said neck opening, to facilitate insertion of said animal's front legs into and through said two front leg openings.

18. A garment for an animal, comprising: a one-piece bodysuit, comprising:
a. a torso portion defining a neck opening and two front leg openings, the torso portion having a topside and a bottom-side; and,
b. a rear portion extending only from the topside of the torso portion and comprising:
i. a front end adjacent the topside of the torso portion and defining a tail opening;
ii. a back end comprising a pair of straps; and,
iii. a central panel extending between the front and the back end, wherein, the rear portion is selectively movable between an open position in which the garment can be removed from the animal and a closed position in which the central panel is held by the pair of straps to cover substantially all of a urogenital region of the animal.

19. The garment of claim 18, wherein the pair of straps are configured for releasable attachment to the top-side of the torso portion of the one-piece bodysuit.

20. The garment of claim 19, wherein when the garment is in the closed position, the straps are attached to the top-side of the torso portion after being extended from the central panel toward a belly region of the animal and upward toward the top-side of the torso portion.
